(19) United States
(12) Patent Application Publication
(10) Pub. No.: US 2009/0313827 A1
(43) Pub. Date: Dec. 24, 2009

(54) METHOD AND A TOOL FOR MANUFACTURING HEAT RADIATOR

(76) Inventors: Kuo-Hsin CHEN, Taipei (TW); Hsuan-Chih Lin, Taipei (TW)

Correspondence Address: HDLS Patent & Trademark Services, P.O. BOX 220746, CHANTILLY, VA, 20153-0746, US

(21) Appl. No.: 12/187,795

(22) Filed: Aug. 7, 2008

(30) Foreign Application Priority Data
Aug. 10, 2007 (TW) 096129519

(51) Int. Cl. B21D 53/02; B23P 19/02

(52) U.S. Cl. 29/890.03; 29/727

(57) ABSTRACT

A method and a tool for manufacturing heat radiators are used to assemble a plurality of radiating fins to a heat transferring base. The method includes the steps of putting the radiating fins on the heat transferring base, putting blades between the radiating fins from at least one side of the heat transferring base, and pressing the blades to deform the heat transferring base to make the heat transferring base tightly fitted with the radiating fins. The tool includes a group of cutters and a pressing part. The cutter has blades having edges and pressing portions opposite to the edges. When the radiating fins are connected to the heat transferring base, the cutter may move between the radiating fins in a direction parallel to the heat transferring base. The pressing part is used for pressing the pressing portion to make the edges deform the heat transferring base, which forces the heat transferring base to be tightly fitted with the radiating fins.

### BACKGROUND OF THE INVENTION

1. Field of the Invention

The invention relates a heat radiator and, more particularly, to a method for assembling radiating fins to a heat transferring base.

2. Description of the Related Art

Under the tendency of pursuing smallness and slimness of electronic devices, the amount of heat in the electronic devices unavoidably and greatly increases. To prevent the high temperature caused by the heat from affecting the operation of the electronic devices, the electronic devices have a higher demand for the heat dissipation. Now, a heat dissipation device is often directly assembled in an electronic device to improve the heat dissipation efficiency.

For the moment, a heat dissipation device often used is a heat radiator with a radiating fin structure. The heat radiator is made of material having a high heat transferring coefficient. Therefore, the heat radiator has a high heat transferring ability. In addition, the heat radiator is light, which decreases the weight, cost and system complexity brought by the heat dissipation device, and it can transfer a great deal of heat without consuming electricity power. Therefore, the heat radiator with radiating fins is widely used as a heat dissipation assembly.

To fix radiating fins on a heat transferring base of a conventional heat radiator, in a conventional technology, a cutter having a plurality of blades is used. After the radiating fins are put to the heat transferring base, the blades of the cutter are put into the structure formed by the radiating fins and the heat transferring base from the spaces between the radiating fins from top to bottom. The blades are against the surface of the heat transferring base to punch to press the surface of the heat transferring base. Thus, the heat transferring base is deformed, and it extrudes the connecting structure of the radiating fin and the heat transferring base, which makes the connection of the radiating fin and the heat transferring base firm.

### SUMMARY OF THE INVENTION

One objective of the invention is to provide a method and a tool for manufacturing heat radiators and assembling radiating fins to a heat transferring base. The cutters are put into the radiating fins and the heat transferring base from two sides in two-segment modes. Then, the cutters are pressed to extrude the surface of the heat transferring base to fix the radiating fins to the heat transferring base. Therefore, the problem that the cutter in the conventional method is too thin to sustain the pressure given by a force is avoided.

To obtain the above and other objectives, the invention provides a method and a tool for manufacturing a heat radiator. The method includes the steps of putting a radiating fin on a heat transferring base, putting blades into the radiating fins from at least one side of the heat transferring base, and pressing the blades to deform the heat transferring base to allow the heat transferring base to tightly fitted with the radiating fins. The tool includes a group of cutters and a pressing part. The cutter has a plurality of blades having edges and pressing portions opposite to the edges. When the radiating fins are connected to the heat transferring base, it moves between the radiating fins in a direction parallel to the heat transferring base. The pressing part is used to press the pressing portions to make the edge deform the heat transferring base. Thus, the heat transferring base is tightly fitted with the radiating fins.

These and other features, aspects, and advantages of the present invention will become better understood with regard to the following description, appended claims, and accompanying drawings.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a sectional diagram showing a structure according to one embodiment of the invention;

FIG. 2 is a three-dimensional schematic diagram showing a structure according to one embodiment of the invention;

FIG. 2A is a partial enlarged diagram according to one embodiment of the invention;

FIG. 3 is a first sectional diagram showing an operation according to one embodiment of the invention;

FIG. 4 is a sectional diagram showing the operation from another angle according to one embodiment of the invention;

FIG. 5 is a second sectional diagram showing the operation according to one embodiment of the invention;

FIG. 6 is a third sectional diagram showing the operation according to one embodiment of the invention;

FIG. 7A to FIG. 7C are first partial enlarged diagrams according to one embodiment of the invention;

FIG. 8 is a second partial enlarged diagram according to one embodiment of the invention;

FIG. 9 is a sectional diagram showing the finished structure according to one embodiment of the invention; and

FIG. 10 is a sectional diagram showing the finished structure according to one embodiment of the invention.

### DETAILED DESCRIPTION OF THE INVENTION

The content of the invention is described with the drawings.

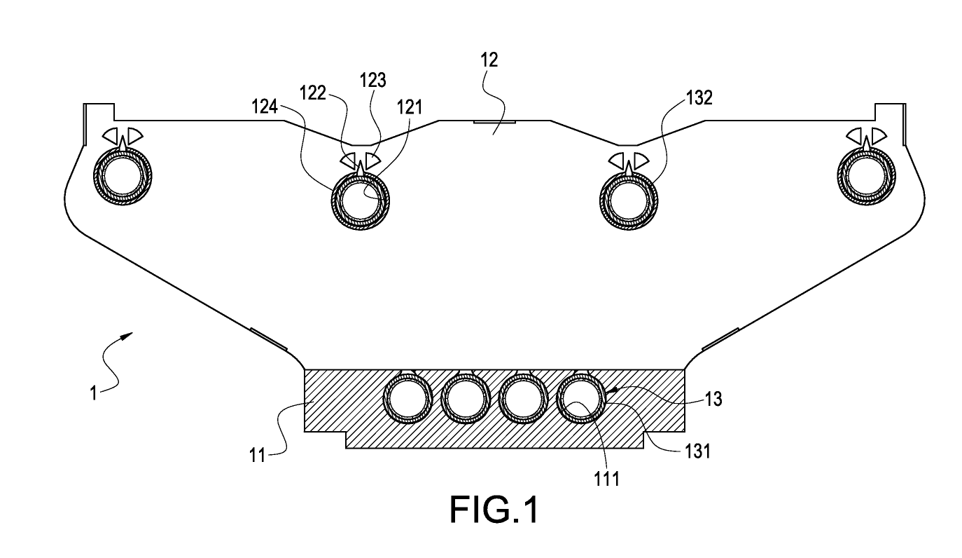

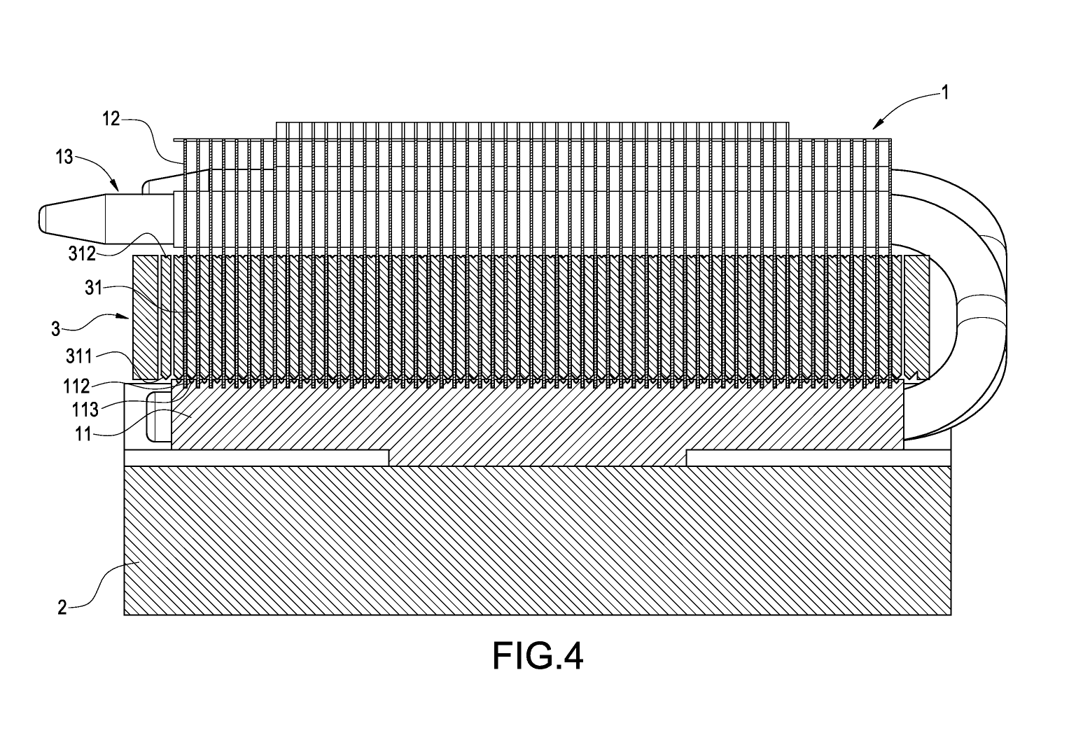

FIG. 1 is a sectional diagram showing a structure according to the embodiment of the invention. In the embodiment, a heat radiator with heat pipes is described. As shown in FIG. 1, the heat radiator 1 mainly includes a heat transferring base 11, a plurality of radiating fins 12 and a plurality of heat pipes 13. The heat transferring base 11 has a plurality of first through holes for heat pipes 13 to pass through (which is described in detail hereinbelow). The radiating fins 12 are connected to the upper surface of the heat transferring base 11, and a plurality of slots 112 are formed on the surface of the heat transferring base 11. In the embodiment, the radiating fins 12 are vertically arranged at the slots 112 (as shown in FIG. 4 which is a sectional diagram) of the heat transferring base 11 at intervals. Cuts 113 are formed at the surface of the heat transferring base 11 between any two slots 112. The body of each radiating fin has a plurality of second through holes 121 for the heat pipes 13 to pass through. A gap 122 communicating with the second through hole 121 is formed at the upper edge of the second through hole 121. In the embodiment, the gap 122 is triangular. Third through holes 123 are formed near two sides of the gap 122 of the radiating fin 12. In the embodiment, the third through hole 123 is triangular, and it does not communicate with the second through hole 121 and the gap 122. In addition, a protruding ring 124 is disposed at the periphery of the second through hole 121 to allow the radiating fins 12 arranged at intervals to have same spacing distances. The heat pipe 13 in the embodiment is U-shaped, and it has a heat collecting end 131 and a condensing end 132. The heat collecting end 131 passes through the first through hole 111 of the heat transferring base 11, and the condensing end 132 passes through the second through hole 121 of the radiating fin 12. In addition, a pressing strip 10 is disposed in the third through hole 123.

The method for assembling the heat transferring base 11 to the radiating fins 12 according to the embodiment of the invention is described hereinbelow.

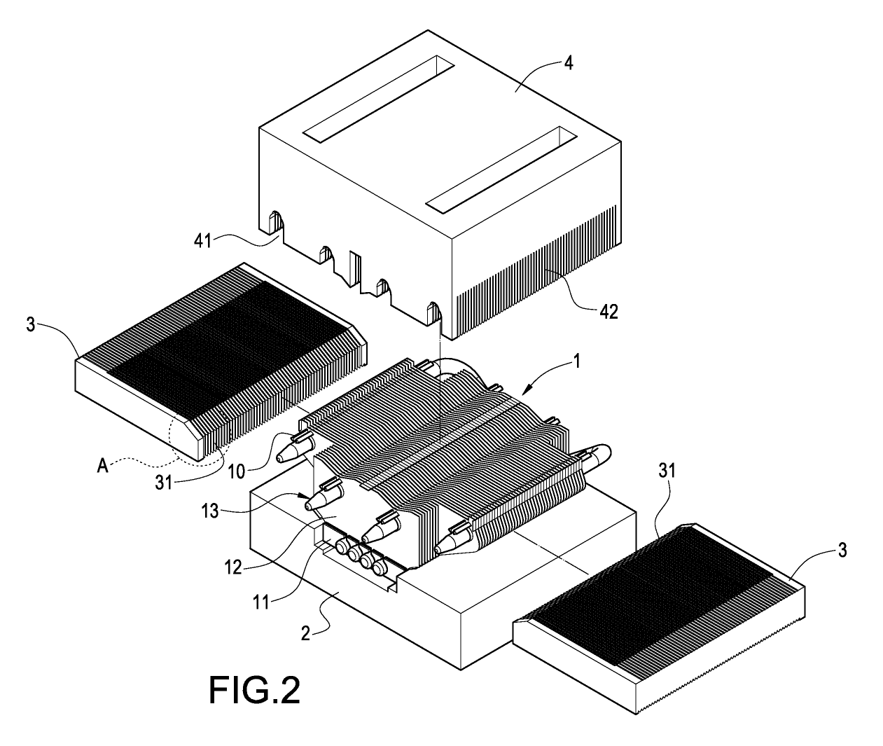

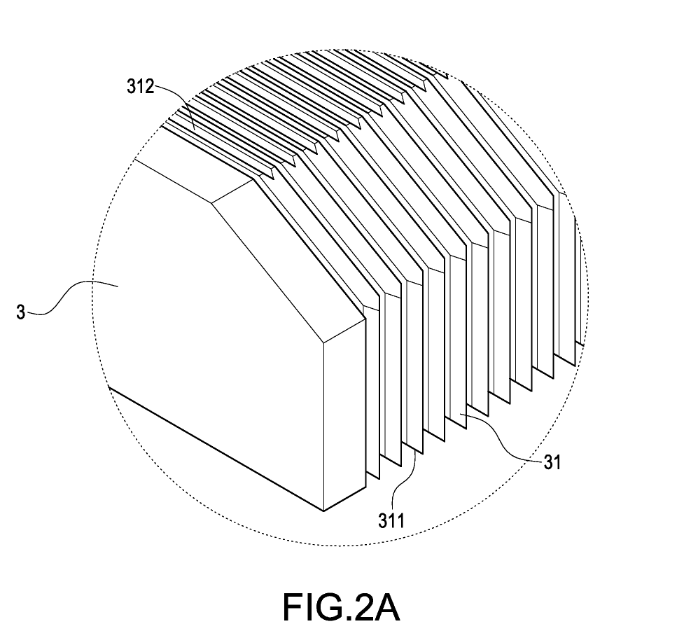

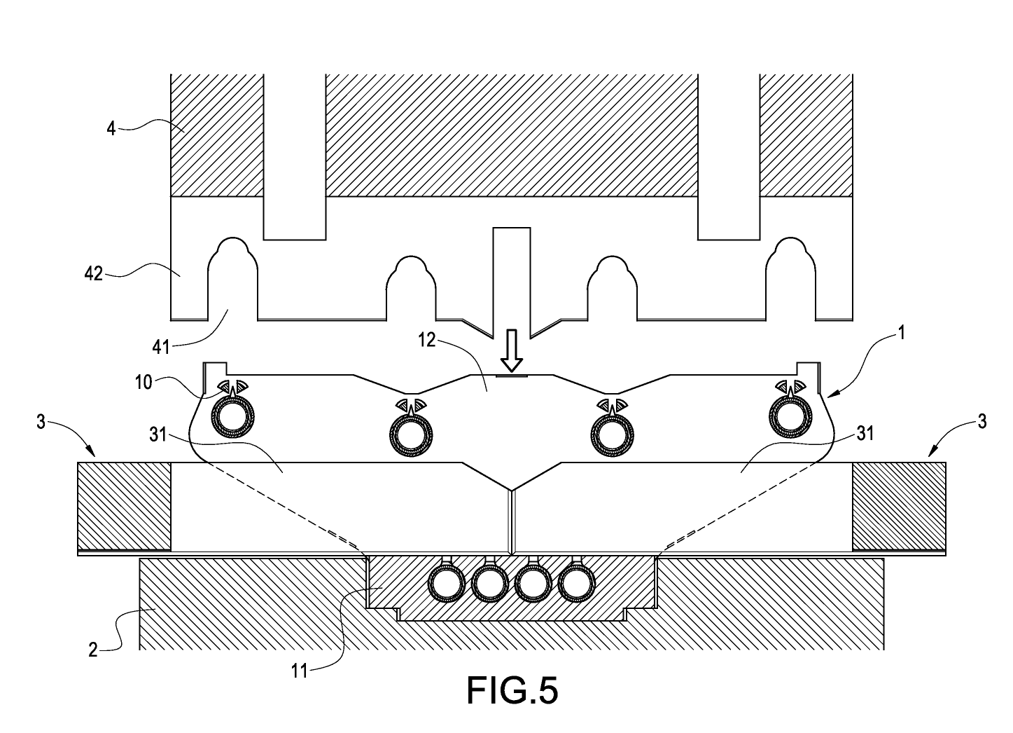

FIG. 2 is a three-dimensional schematic diagram showing the structure according to the embodiment of the invention. As shown in FIG. 2, the radiating fins 12 are put to the heat transferring base 11, and then the obtained heat radiator 1 is put on a mold base 2. At least a cutter 3 (a plurality of cutters are taken for example in the embodiment) and a pressing part 4 are prepared. The front end of the cutter is trapezoidal, and the cutter 3 has a plurality of blades 31. The thickness of the blade 31 allows the blade to pass through a space formed by any two radiating fins 12 appropriately. The space formed by any two blades also may accommodate the radiating fin 12 appropriately. Each blade 31 has an edge 311 and a pressing portion 312 opposite to the edge 311 at the top and bottom, respectively, as shown in FIG. 2 A. In addition, the pressing part 4 has a plurality of lengthwise long recesses 41 at the bottom, and a plurality of widthwise sheet-shaped accommodating spaces 42. The position of the long recesses 41 corresponds to the position of the heat pipe passing through the radiating fins 12. The position of the sheet-shaped accommodating spaces 42 corresponds to the position of the radiating fins 12 to make the accommodating spaces 42 accommodate the radiating fins 12 to keep the completeness of the radiating fins 12 when the pressing part 4 presses downward (as shown by an arrow in FIG. 5).

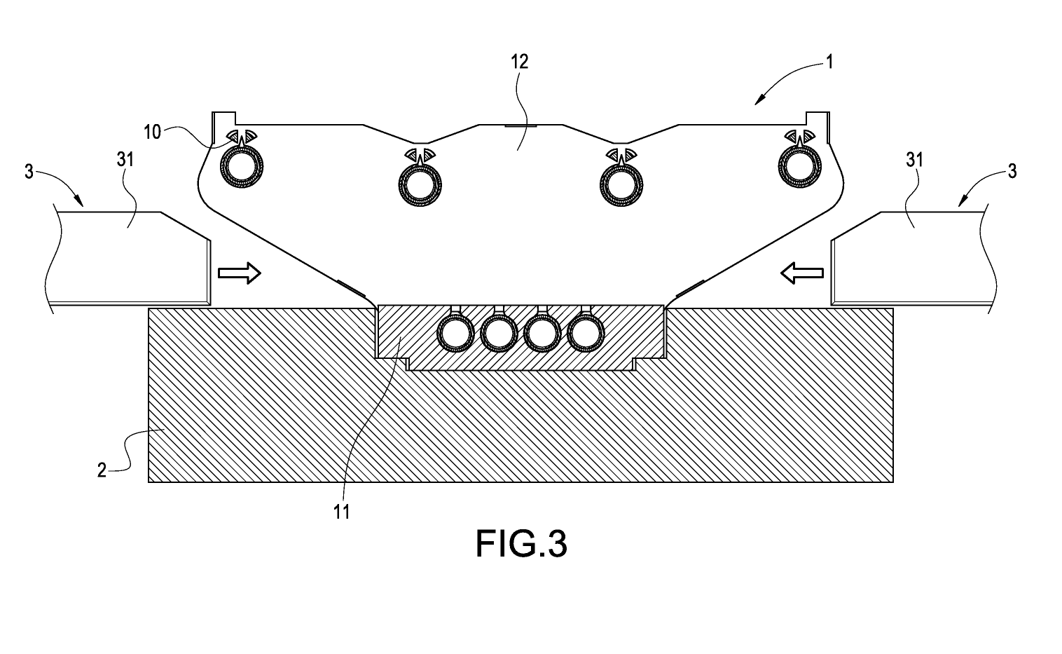

FIG. 3 is a sectional diagram showing the operation according to the embodiment of the invention. After the heat radiator 1 is put onto the mold base 2, the cutters 3 are pushed into the heat radiator 1 from the right and left sides of the heat radiator 1 (as shown by the arrows in FIG. 3). The edges 311 of the blades 31 of the cutters 3 are against the heat transferring base 11 of the heat radiator 1, as shown in FIG. 4 which is a sectional diagram showing the operation form another angle.

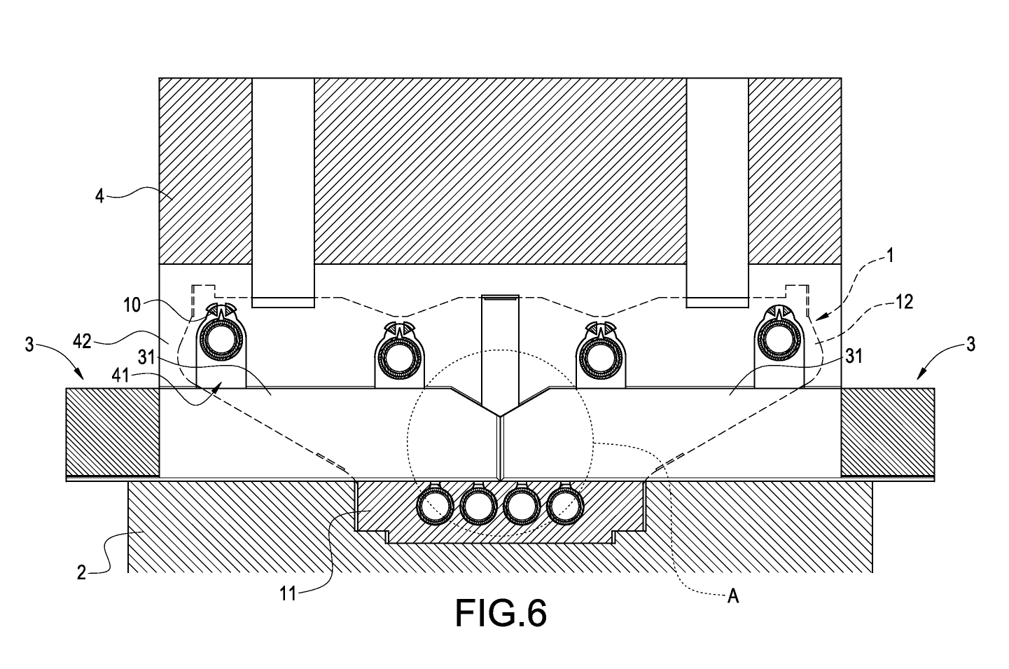

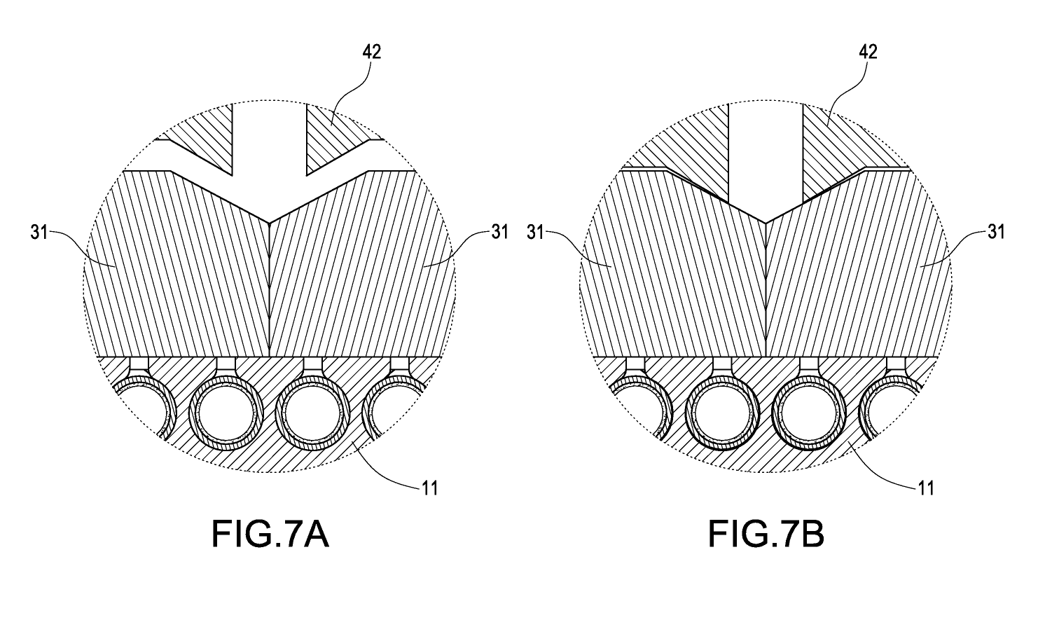

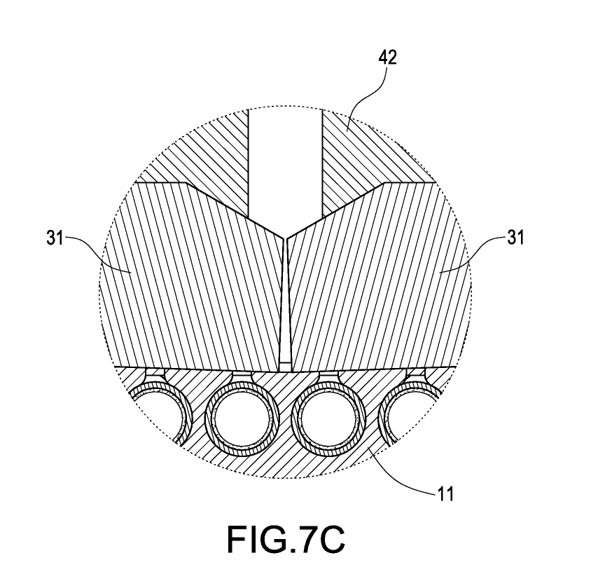

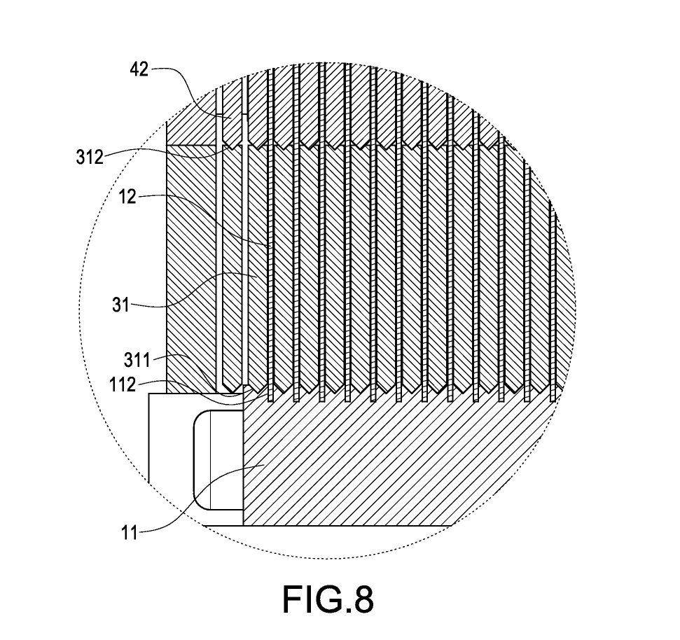

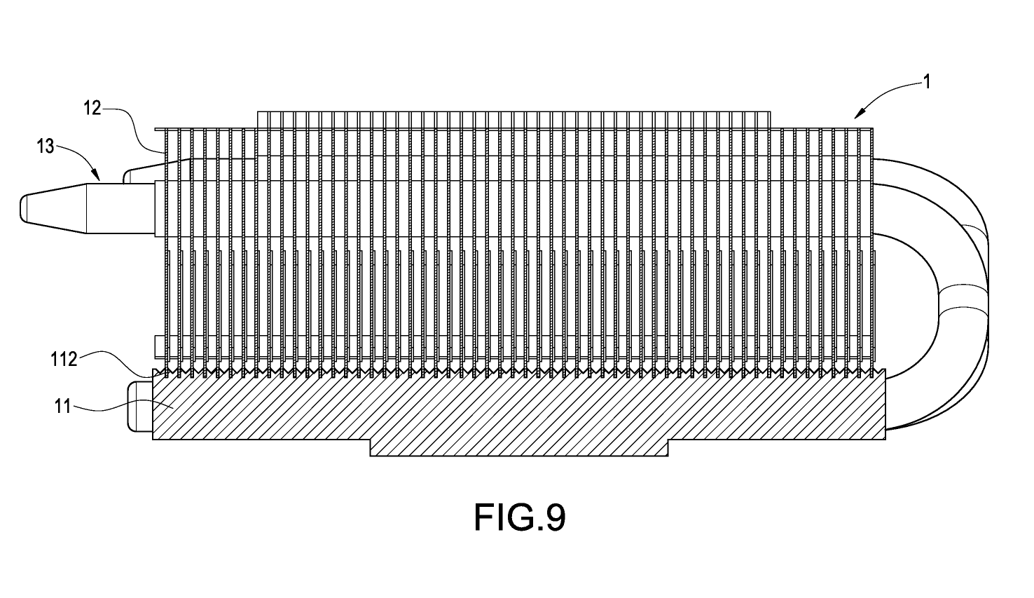

FIG. 5 is a sectional diagram showing the operation according to one embodiment of the invention. The pressing part 4 is used to press toward the inside of the heat radiator 1. When the radiating fins 12 are all accommodated in the widthwise accommodating spaces 42, the top of the lengthwise recess 41 corresponds to the position of the pressing strips 10. As shown in FIG. 6, when the pressing part presses downward, the top of each recess 41 of the pressing part 4 is against each pressing strip 10 first. When the pressing part continues pressing, it drives the pressing strip 10 to move toward the gap 122 to compress the gap 122 by the pressing force of the pressing part 4. At the same time, the periphery of the second through hole 121 of the radiating fin 12 is driven to be closely connected with the periphery of the condensing end 132 of the heat pipe 13. FIG. 7(A) to FIG. 7(c) are partial enlarged diagrams. When the pressing part 4 is pressed to the heat pipe 13, the bottom of the pressing part 4 is just against the pressing portion 312 of the cutters 3, and pressing force of the pressing part 4 also drives the cutters 3 to press toward the heat transferring base 11. Thus, each edge 311 of the blade 31 extrudes the cut 113 on the surface of the heat transferring base 11 to make the surface deformed. FIG. 8 is a partial enlarged diagram. The connecting part of the heat transferring base 11 and the radiating fin 12 is extruded to fix the radiating fin 12 on the heat transferring base 11. Finally, the pressing part 4 and the cutter 3 are taken out in sequence. The structure of the heat radiator is obtained, as shown in the FIG. 9 which is a sectional diagram showing the finished structure.

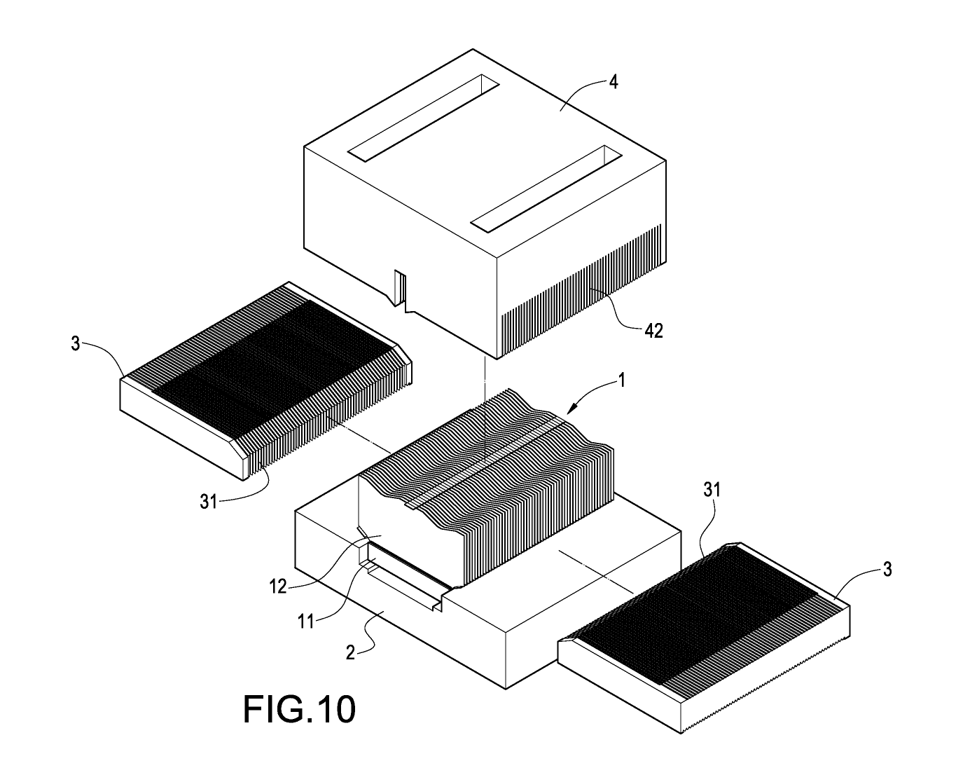

In addition, as shown in FIG. 10, the method also may be adapted to the heat transferring base 11 and the radiating fins 12 without the heat pips.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for manufacturing a heat radiator and assembling a plurality of radiating fins and a heat transferring base, the method comprising the steps of:
putting the radiating fins on the heat transferring base;
providing a plurality of blades;
putting the blades between the radiating fins from at least one side of the heat transferring base; and
pressing the blades to deform the heat transferring base to force the heat transferring base to be tightly fitted with the radiating fins.

2. The method according to claim 1, wherein the step of providing the blades comprises the step of providing the blades each of which has an edge and a pressing portion opposite to the edge.

3. The method according to claim 2, wherein the step of putting the blades between the radiating fin from the side of the heat transferring base comprises the step of putting the blades between the radiating fins in a direction parallel to the heat transferring base to allow the direction of the edge to be toward the heat transferring base.

4. A tool for manufacturing a heat radiator and assembling a plurality of radiating fins and a heat transferring base, the tool comprising:
a mold base for bearing the heat radiator;
at least a cutter having at least a blade having an edge and a pressing portion opposite to the edge, wherein when the radiating fins are connected to the heat transferring base, the cutter moves between the radiating fins in a direction parallel to the heat transferring base; and
a pressing part for pressing the pressing portion to make the edge deform the heat transferring base to force the heat transferring base to be tightly fitted with the radiating fins.

5. The tool according to claim 4, wherein the bottom of the pressing part has a plurality of widthwise accommodating spaces for accommodating the radiating fins.

6. The tool according to claim 4, wherein one end of the cutter is trapezoidal.
